(19) United States
(12) Patent Application Publication
(10) Pub. No.: US 2016/0202085 A1
(43) Pub. Date: Jul. 14, 2016

(54) Non-contact Axial Articulation Sensing

(71) Applicant: Caterpillar Inc., Peoria, IL (US)

(72) Inventors: Darren Brent Rydell, St. Joseph, IL (US); Terry William Howard, Champaign, IL (US); Ethan Michael Tevis, Bloomington, IL (US)

(73) Assignee: CATERPILLAR INC., Peoria, IL (US)

(21) Appl. No.: 14/594,960

(22) Filed: Jan. 12, 2015

(51) Int. Cl. G01D 5/14

(52) U.S. Cl. CPC G01D 5/145

(57) ABSTRACT

An assembly of an alignment tool and a sensing apparatus for non-contact sensing of axial articulation are disclosed. The sensing apparatus includes a first member, and a second member. The first member includes a housing and a non-contact sensor disposed inside a chamber of the housing. The second member includes a base including a side surface, a stem disposed on the base and defining a cavity, first and second supports disposed on the side surface, and a magnet disposed in the cavity. The alignment tool includes a floor, an inner wall, and an outer wall that define a channel. The alignment tool is configured to align the non-contact sensor over the magnet and to provide a gap between the non-contact sensor and the magnet when the channel is disposed between the first and second members.

### TECHNICAL FIELD

The present disclosure generally relates to axial articulation sensing for machines in which a portion of the machine articulates or pivots with respect to another portion of the machine and, more particularly, relates to non-contact axial articulation sensing of the angular displacement of such articulation.

### BACKGROUND

Some types of machines, for example, articulated machines, include frames in which one portion of the frame may articulate about a pivot axis. It is important to be able to determine the articulation angle of the articulating, or rotating, portion of the machine. Conventional sensing apparatus that are driven by a mechanical linkage may not provide the most accurate articulation readings due to mechanical wear and component variability that can result in inconsistent translation of the machine angle due to the linkage. Furthermore, it may not be desirable to use such mechanical linkage driven sensors in inclement weather where ice may form on the mechanical linkage and result in drag and possible interruption of the linkage operation.

U.S. Pat. No. 6,218,828 discloses an apparatus that includes a magnet attached to a first element and first and second sensing devices adapted to detect a magnetic flux density produced by the magnet. Precise alignment of the sensing device(s) and the magnet of such an apparatus is desirable in order to obtain the accurate readings. There is a need for improvements relating to the alignment of such sensing devices and magnets.

### SUMMARY OF THE DISCLOSURE

In accordance with one aspect of the disclosure, an assembly of an alignment tool and a sensing apparatus is disclosed. The assembly comprises a sensing apparatus and an alignment tool. The sensing apparatus includes a first member, and a second member. The first member includes a housing defining a chamber, and a non-contact sensor disposed in the chamber. The second member includes a base including a side surface, a stem disposed on the base, first and second supports disposed on the side surface, and a magnet disposed in the cavity. The stem defines a cavity. The alignment tool includes a floor, an inner wall disposed on the floor, and an outer wall spaced apart from the inner wall and disposed on the floor. The inner wall defines a recess configured to receive the stem when the floor is disposed on the first and second supports. The floor, inner wall and outer wall define a channel. The alignment tool is configured to align the non-contact sensor over the magnet and to provide a gap between the non-contact sensor and the magnet when the channel is disposed between the first and second members.

In accordance with another aspect of the disclosure, a method of assembling a sensing apparatus on a machine having a first frame and a second frame is disclosed. The second frame is pivotally connected to the first frame about a pivot axis. The sensing apparatus includes a first member and a second member. The first member includes a non-contact sensor, and the second member includes a magnet. The method includes disposing a channel around the first member, aligning the non-contact sensor over the magnet and providing a generally uniform gap between the non-contact sensor and the magnet by positioning the channel on the second member, and removing the channel from contact with the first and second members.

In accordance with a further aspect of the disclosure, a machine is disclosed. The machine includes a first frame, a second frame pivotally connected to the first frame about a pivot axis, a first member mounted on the first frame, and a second member mounted on the second frame. The first member includes a housing defining a chamber, and a Hall effect sensor disposed in the chamber. The Hall effect sensor is configured to measure a pivotable displacement of the second frame with respect to the first frame based on rotational movement of a magnet aligned with the Hall effect sensor. The Hall effect sensor is further configured to generate a signal indicative of the pivotable displacement. The second member includes a base including a side surface, a stem disposed on the base, first and second supports disposed on the side surface, and the magnet disposed in the cavity. The stem defines a cavity. A gap is disposed between the first member and the second member.

### BRIEF DESCRIPTION OF THE DRAWINGS

FIG. 1 is a perspective view of an exemplary assembly for aligning a sensing apparatus for non-contact sensing of axial articulation, the sensing apparatus including a first member and a second member;

FIG. 2 is a front view of the assembly of FIG. 1;

FIG. 3 is another perspective view of the assembly of FIG. 1;

FIG. 4A is a top perspective view of an exemplary second member of the assembly of FIG. 1;

FIG. 4B is a bottom perspective view of the second member of FIG. 4A;

FIG. 5 is a perspective view of an exemplary alignment tool of the assembly of FIG. 1;

FIG. 6 is side view of one exemplary machine that incorporates the sensing apparatus for non-contact sensing of axial articulation;

FIG. 7 is a flowchart depicting a sample sequence of blocks which may be practiced in accordance with an exemplary method employing the teachings of the present disclosure;

FIG. 8 is an enlarged perspective view of the sensing apparatus with a first member mounted to a first frame of the exemplary vehicle of FIG. 6 and the second member mounted to a second frame of the vehicle of FIG. 6;

FIG. 9 is an enlarged perspective view of an alternative mounting of a sensing apparatus to the exemplary vehicle of FIG. 6, shown with the alignment tool still around the sensing apparatus;

FIG. 10 is an exemplary shim that may be used in conjunction with the sensing apparatus;

FIG. 11A is a schematic illustration showing a top view of an enlarged portion of the machine of FIG. 6 with the second frame of the machine, and the second member and magnet of the sensing apparatus, at approximately zero degrees angular displacement from the X-axis;

FIG. 11B is a schematic illustration like FIG. 11A, but with the second frame of the machine, and the second member and magnet of the sensing apparatus, at approximately α degrees angular displacement from the X-axis in the clockwise direction; and

FIG. 11C is a schematic illustration like FIG. 11A, but with the second frame of the machine, and the second member and magnet of the sensing apparatus, at approximately −α degrees angular displacement from the X-axis in the counterclockwise direction.

### DETAILED DESCRIPTION

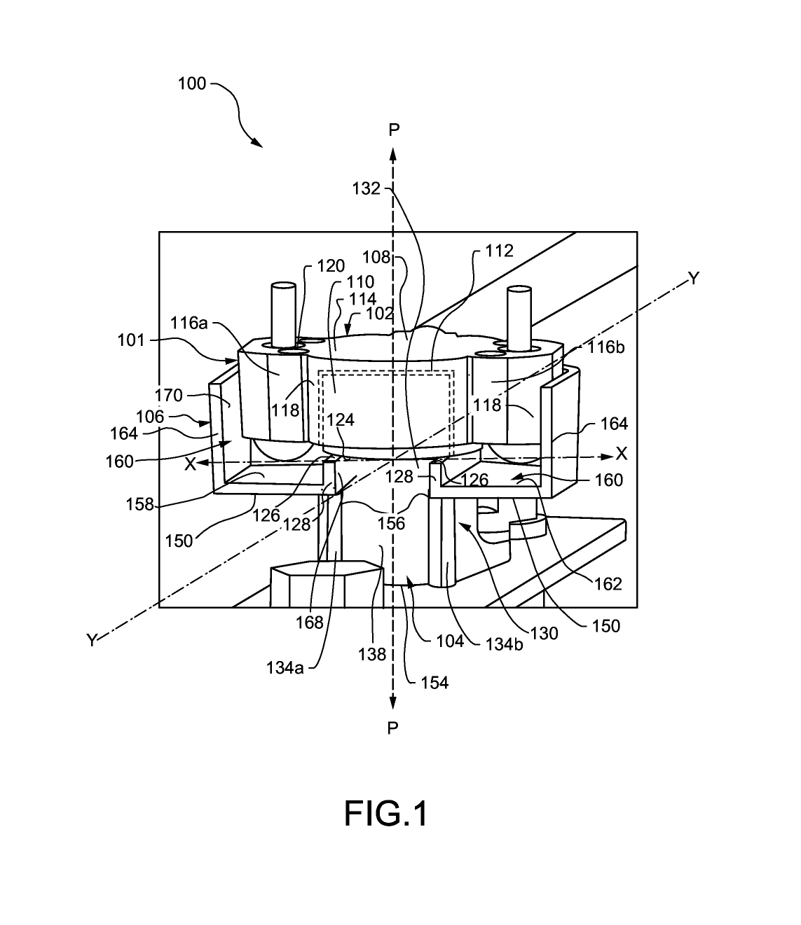

Referring now to the drawings, and with specific reference to FIGS. 1-3, there is shown an assembly of an alignment tool and an apparatus for non-contact sensing of axial articulation, or, in other words, pivotal angular displacement about a pivot axis P. The assembly is constructed in accordance with the present disclosure and is generally referred to by reference numeral 100. The assembly 100 comprises a sensing apparatus 101 for non-contact sensing of axial articulation and an alignment tool 106.

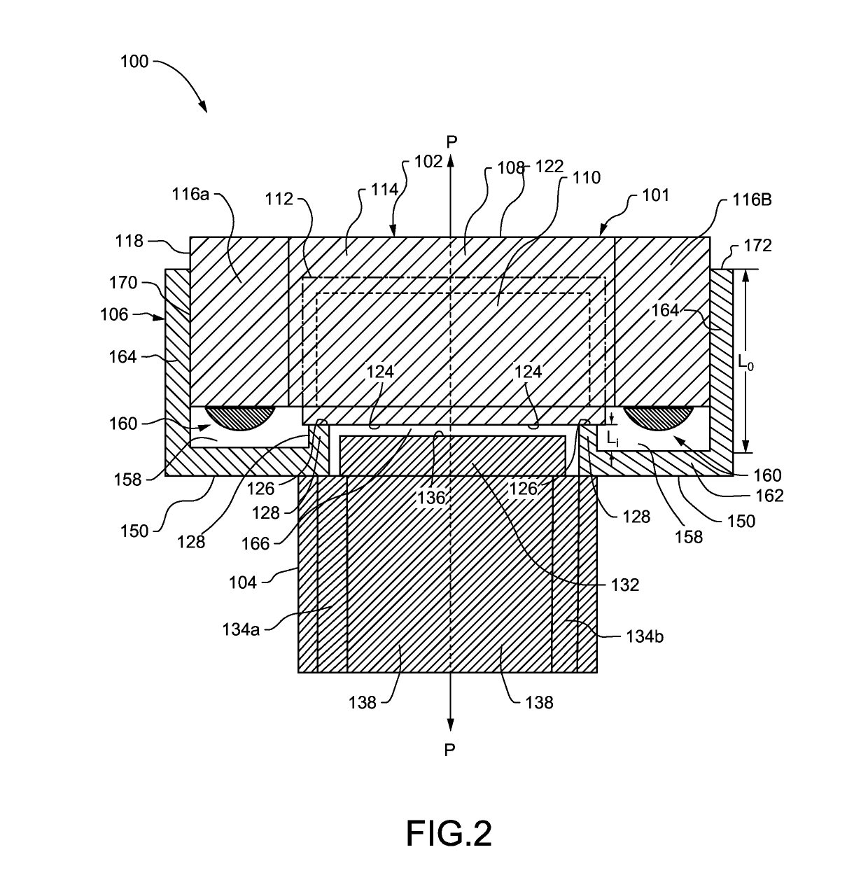

The sensing apparatus 101 includes a first member 102, and a second member 104. The first member 102 includes a housing 108 and a non-contact sensor 110. The housing 108 defines a chamber 112. The housing 108 may further include a core portion 114 disposed between a first wing 116a and a second wing 116b. The housing 108 further includes a sidewall 118 that extends around the core portion 114, the first wing 116a and the second wing 116b and forms an exterior surface of the housing 108. The first wing 116a and the second wing 116b may each include a bore 120 therethrough. The chamber 112 is disposed in the core portion 114. The core portion 114 has a top surface 122 and a bottom surface 124 that extends from side to side of the core portion 114 and covers the chamber 112. The bottom surface 124 is configured to receive and slidingly release the alignment tool 106. In one embodiment, the bottom surface 124 may be configured to receive and slidingly release an upper edge 126 of the inner wall 128 of the alignment tool 106 (see FIGS. 1-2).

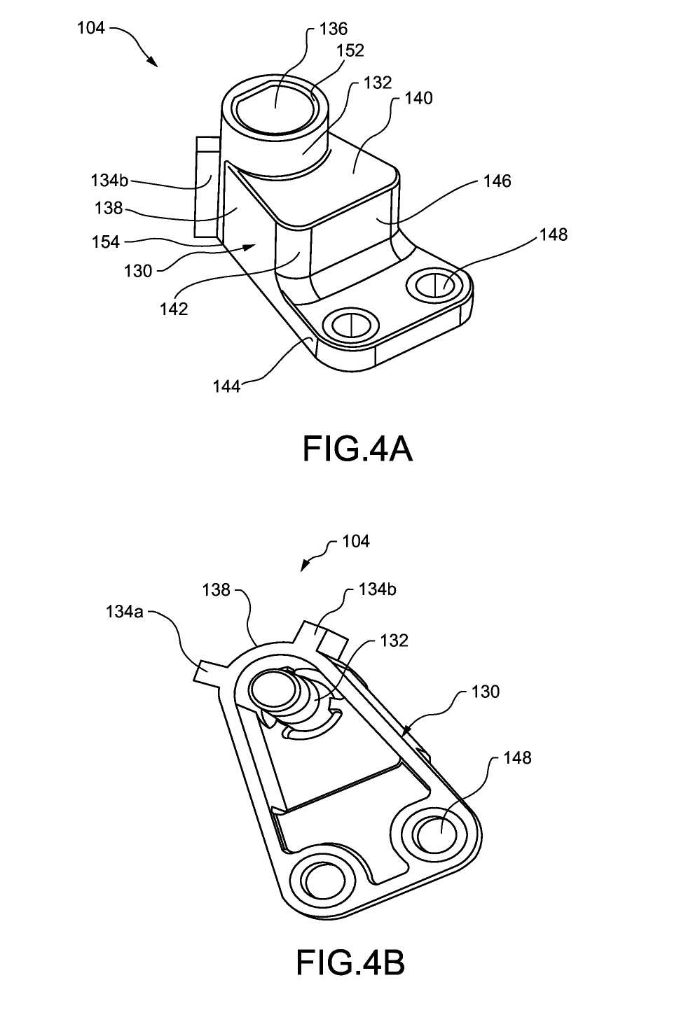

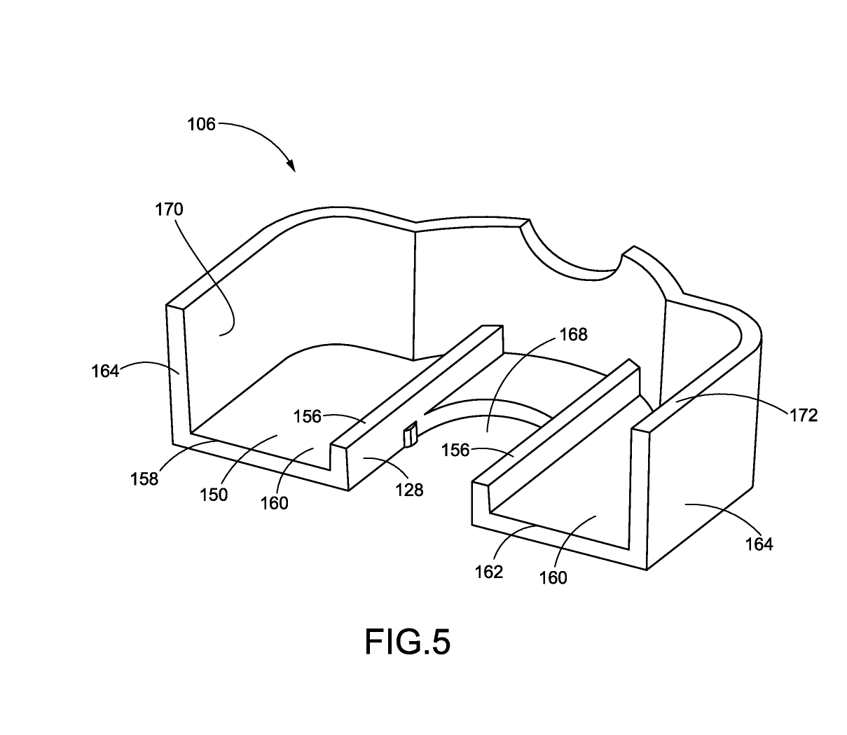

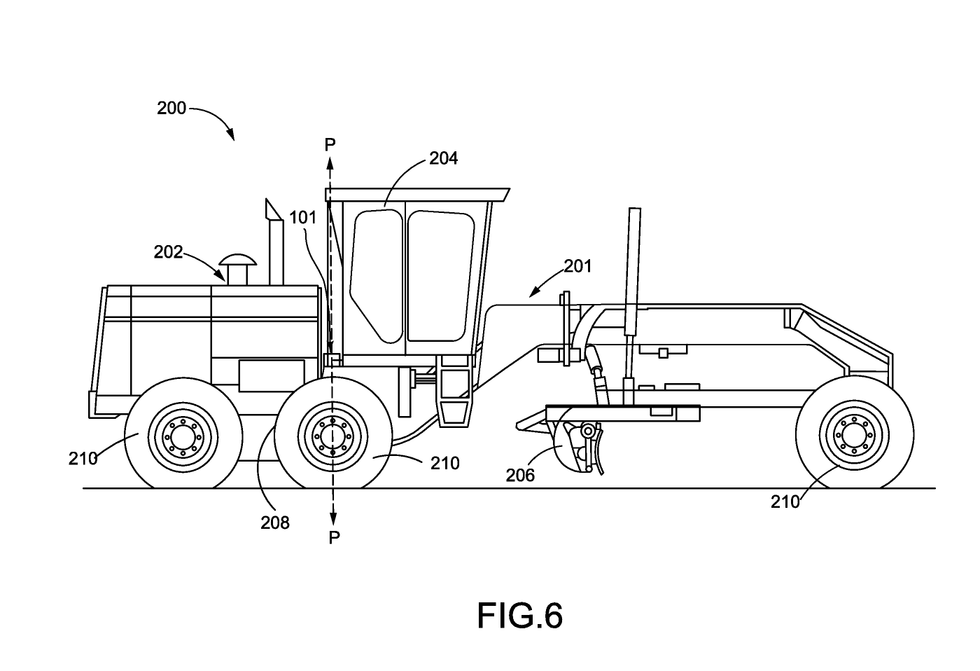

The non-contact sensor 110 is disposed in the chamber 112 of the housing 108. The non-contact sensor 110 is configured to detect and measure the axial articulation (angular pivotable displacement) about the pivot axis P of a second frame 202 (FIG. 6) of a machine 200 with respect to a first frame 201 of the machine 200. More specifically, the non-contact sensor 110 is configured to detect and measure the magnetic flux density produced by a magnet 136 (FIG. 4A) disposed in the second member 104 (mounted on the second frame 202). The non-contact sensor 110 is further configured to generate, in response to the measurement, a signal indicative of the intensity of the detected magnetic flux. In one embodiment, the first frame 201 may be substantially stationary relative to the second frame 202. The intensity of the magnetic flux will vary with the rotation of the magnet 136 about the pivot axis P when the second frame 202 articulates about the pivot axis P with respect to the first frame 201 (on which the first member 102 and the non-contact sensor 110 is mounted). The intensity is indicative of the axial articulation of the second frame with respect to the pivot axis P and the first frame 201. In one embodiment the non-contact sensor 110 may be a Hall effect sensor. Alternatively, other sensing devices that detect axial articulation in a non-contacting manner may be used.

FIG. 4A illustrates an exemplary embodiment of the second member 104. The second member 104 includes a base 130, a stem 132, a first support 134a (see FIGS. 1, 2 and 4B), a second support 134b, and the magnet 136 (FIG. 4A) having a north and south pole. FIG. 4B illustrates a perspective view as seen from the bottom of the exemplary second member 104 of FIG. 4A.

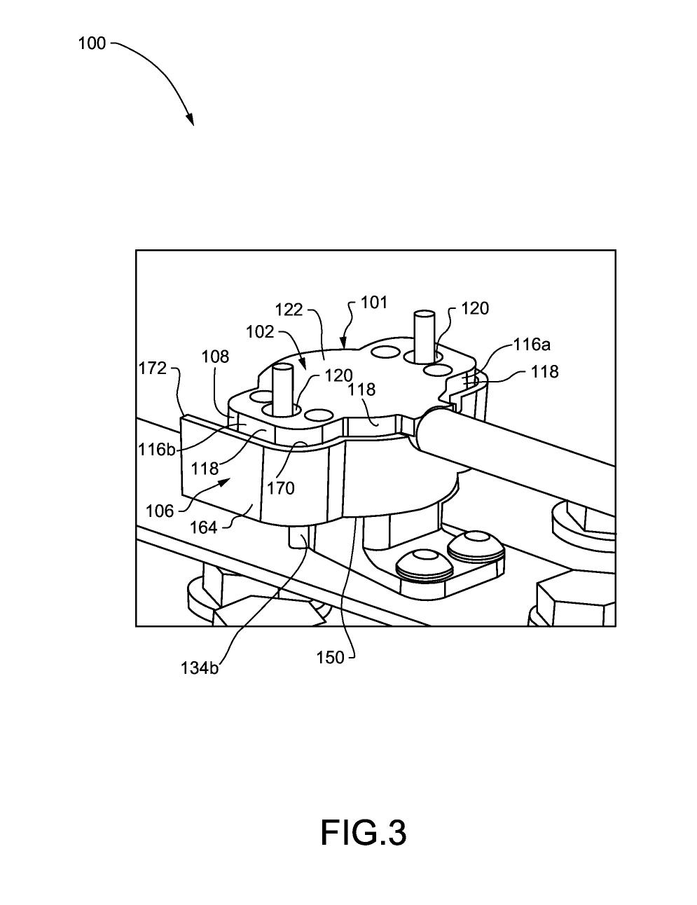

As best seen in FIG. 4A, the base 130 surrounds a portion of the stem 132 and includes a side surface 138 and a platform surface 140. The base 130 may have a stepped profile with one or more steps 142. For example, in the embodiment illustrated in FIG. 4A, the base 130 includes a lower step 144 and an upper step 146 disposed above the lower step 144 and below a portion of the stem 132. The lower step 144 may include one or more mounting bores 148 therethrough. In the embodiment of FIG. 4A, the platform surface 140 is defined by the top of the upper step 146 and, in some embodiments, may be generally perpendicular to the side surface 138. In other embodiments, the platform surface 140 may not be perpendicular to the side surface 138. The platform surface 140 is configured to receive and support the alignment tool 106 (or more specifically a floor 150 of the alignment tool 106, as shown in FIG. 3) and slidingly release the floor 150 of the alignment tool 106. For the purposes of discussion herein, slidingly release of the floor 150 of the alignment tool 106, means that the platform surface 140 is configured to allow the alignment tool 106 to be removed from the platform surface 140 by sliding the floor 150 of the alignment tool 106 over the platform surface 140.

The stem 132 is disposed on the base 130. As can be seen in the embodiment illustrated in FIG. 4A, part of the stem 132 may be disposed above the platform surface 140 and, as can be seen in FIG. 4B, the remainder part (of the stem 132) may be disposed below the platform surface 140. The stem 132 defines a cavity 152 (FIG. 4A) in which the magnet 136 is disposed.

As shown in FIGS. 1, 2 and 4B, the first support 134a and the second support 134b are spaced apart from each other and are disposed on the side surface 138 of the base 130 near the stem 132. In one embodiment, the first and second supports 134a, 134b may be substantially below the platform surface 140 (see FIG. 4A). For example, as shown in FIGS. 1 and 4A, the first support 134a and the second support 134b may each be generally vertical pillars that extend from the base bottom 154 to a plane that contains the platform surface 140 (see FIG. 4A). Each of the first and second supports 134a, 134b includes an interface 156 (FIG. 1). In an embodiment, each interface 156 may be disposed in the plane that contains the platform surface 140.

In an embodiment, the interface 156 of the first support 134a is configured to receive and support the floor 150 of the alignment tool 106 that is proximal to a first end 158 (FIGS. 1-2) of a channel 160 of the alignment tool 106, and the interface 156 of the second support 134b is configured to receive and support the floor 150 (of the alignment tool 106) that is proximal to a second end 162 of the channel 160 of the alignment tool 106. The first and second supports 134a, 134b and their respective interfaces 156 are also configured to slidingly release the alignment tool 106 when such alignment tool 106 is removed from the interface 156 of each of the first and second supports 134a, 134b. For the purposes of discussion herein, slidingly release the alignment tool 106 means that interface 156 of each of the first and second supports 134a, 134b is configured to allow the alignment tool 106 to be removed from the interface 156 by sliding the floor 150 of the alignment tool 106 over the interface 156.

The alignment tool 106 includes the floor 150, the inner wall 128 disposed on the floor 150, and an outer wall 164 spaced apart from the inner wall 128 and disposed on the floor 150. The inner wall 128, the floor 150 and the outer wall 164 define the channel 160, which has the first end 158 and the second end 162 (as mentioned above). In some embodiments, the channel 160 may be generally curved or U-shaped.

The alignment tool 106 is configured to align the non-contact sensor 110 over the magnet 136 (FIG. 4A) in a first axial direction Y (FIG. 1) and in a second axial direction X, and is configured to provide a gap 166 (FIG. 2), in a third axial direction along the pivot axis P, between the non-contact sensor 110 and the magnet 136 when the alignment tool 106 is disposed between the first member 102 and the second member 104. For example, in the embodiment shown in FIGS. 1-2, the alignment tool 106 is configured to align the non-contact sensor 110 over the magnet 136 in a first axial direction Y (side to side) and in a second axial direction X (front to back). The alignment tool 106 is further configured to provide a gap 166, in a direction along the pivot axis P, between the non-contact sensor 110 and the magnet 136 when the inner wall 128 of the channel 160 is disposed between the bottom surface 124 of the first member 102 and both of the first and second supports 134a, 134b of the second member 104. In an embodiment, the gap 166 may be an air gap 166. In the embodiment shown in FIGS. 1-2, the first axial direction Y and the second axial direction X are contained in a plane that is parallel to the platform surface 140 and perpendicular to the pivot axis P. The second axial direction X is perpendicular to the first axial direction Y. The third axial direction (P) extends along the pivot axis P and is perpendicular to both the first and second axial directions Y, X.

The inner wall 128 defines a recess 168 (FIG. 1) configured to receive the stem 132 when the floor 150 (of the alignment tool 106) is disposed on the first and second supports 134a, 134b. The recess 168 is external to the channel 160. The inner wall 128 is configured to extend from the floor 150 to the bottom surface 124 of the core portion 114 of the housing 108 of the first member 102. The inner wall 128 includes an upper edge 126 configured to receive and support the bottom surface 124. The alignment tool 106 (more specifically, the upper edge 126) is configured to be slidably removeable from the bottom surface 124. As shown in FIG. 2, the inner wall 128 is configured to have a length Lᵢ (from the floor 150 to the upper edge 126) that provides a gap 166 between the bottom surface 124 (of the core portion 114 of the first member 102) and the magnet 136 in the stem 132 of the second member 104 when the alignment tool 106 is disposed around the first member 102 while on the first and second supports 134a, 134b of the second member 104.

As best seen in FIG. 3, the outer wall 164 has an inner surface 170 that has a reciprocal contour relative to a portion of the sidewall 118 of the housing 108 of the first member 102 that is configured to matingly receive the portion of the sidewall 118 of the housing 108 of the first member 102. Such mating reception due to the mating parts is referred to herein as reciprocal contact. The length L_{O} (FIG. 2) of the outer wall 164 as measured from the floor 150 to the outer wall upper edge 172 is longer than the length Lᵢ of the inner wall 128 as measured from the floor 150 to the (inner wall) upper edge 126.

FIG. 6 illustrates one example of a machine 200 on which the sensing apparatus 101 may be used. The machine 200 may be a mobile vehicle that performs one or more operations associated with an industry such as earth moving, construction, farming, mining or any other industry known in the art. In the illustrated embodiment, the machine 200 is a motor grader. While the detailed description and drawings herein may be made with reference to mounting on a motor grader, the teachings of this disclosure may be employed on other earth moving, construction, farming or mining machines in which a portion of the machine 200 frame articulates with respect to another portion of the frame.

In the illustrated embodiment, the machine 200 includes a first frame 201, second frame 202 pivotally connected to the first frame 201. More specifically, the second frame 202 in the exemplary embodiment is pivotable about a pivot axis P. The machine 200 further includes a power source such as an engine (not shown), an operator station or cab 204 containing input devices and operator interfaces for operating the machine 200, and a work tool or an implement 206, such as a blade. The input devices may include one or more devices disposed within the cab 204 and may be configured to receive inputs from the operator. The inputs may be indicative of controlling steering and propulsion of the machine 200, operation of the implement 206, braking of the machine 200 and other operations of the machine 200. In the exemplary embodiment, the first frame 201 may be a front frame and the second frame 202, which is pivotable about the first frame 201, may be a rear frame. In other embodiments, the second (pivotable) frame 202 may instead be a front frame and the first frame 201 may be a rear frame.

The machine 200 may include ground engaging members 210. The ground engaging members 210 may be adapted for steering and maneuvering the machine 200, and for propelling the machine 200 in forward and reverse directions. In the illustrated embodiment in FIG. 6, the ground engaging members 210 are wheels. However, in an alternative embodiment, the ground engaging members 210 may include track assemblies. The ground engaging members 210 may be operatively connected by a tandem drive assembly 208.

### INDUSTRIAL APPLICABILITY

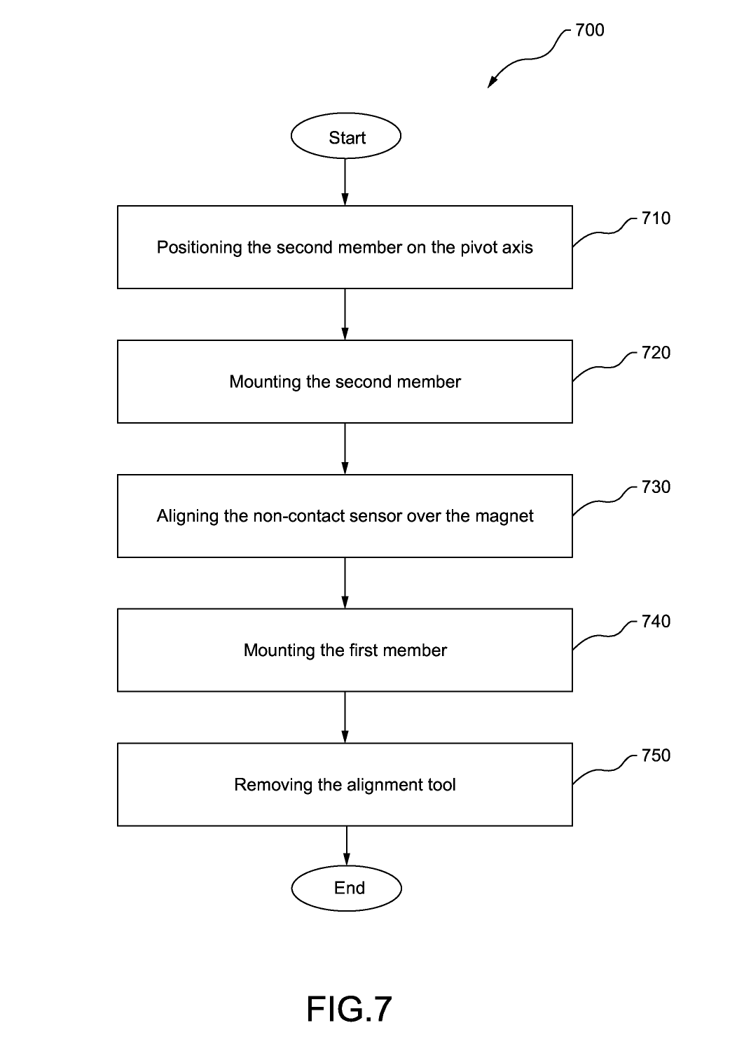

Also disclosed is an exemplary method of assembling the sensing apparatus 101 on a machine 200 having a first frame 201 and a second frame 202, the second frame 202 pivotally connected to the first frame 201. Referring now to FIG. 7, the exemplary method 700 is illustrated showing sample blocks that may be followed in the method for assembling the sensing apparatus 101 on a machine 200. The method 700 may be practiced with more or less than the number of blocks shown.

Block 710 includes positioning the second member 104 on the second frame 202 in a location in which the magnet 136 that is disposed in the cavity 152 of the stem 132 is substantially centered on the pivot axis P.

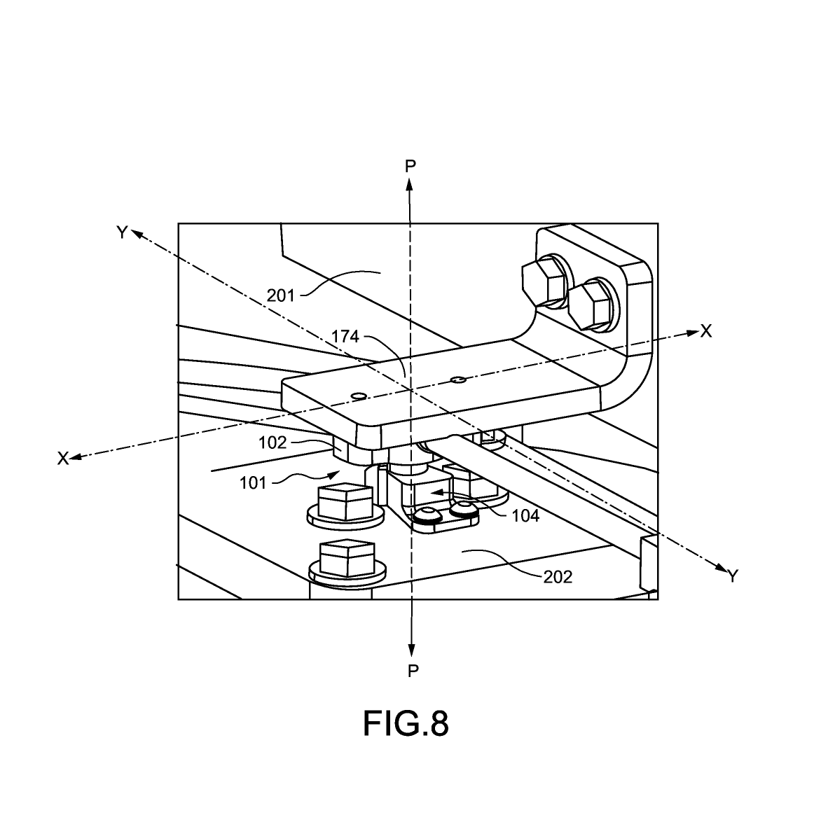

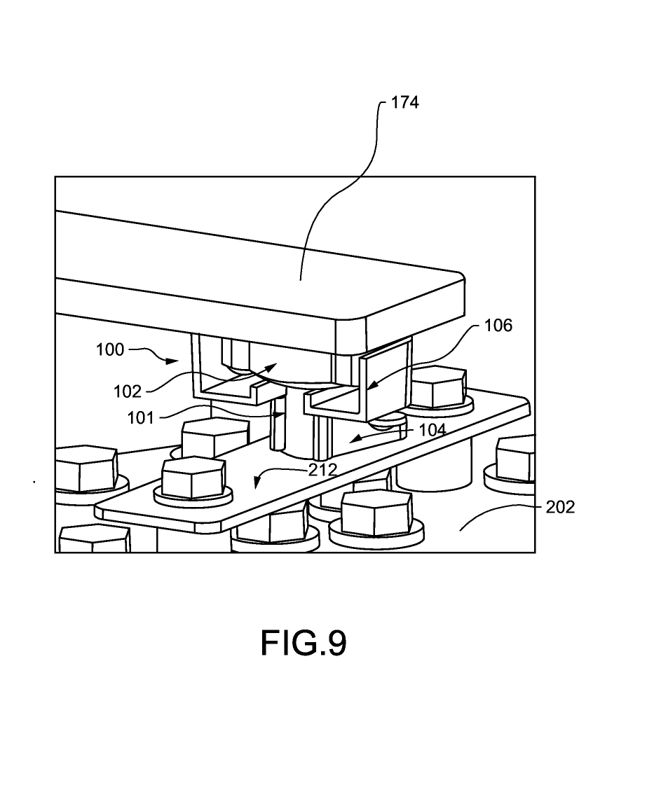

Block 720 includes mounting the second member 104, (FIG. 4a) directly or indirectly, to the second frame 202 (FIG. 6) at the location that is a result of the positioning of block 710. In some embodiments, such as the one illustrated in FIG. 8, the second member 104 may be mounted directly to the second frame 202 by bolts, or the like, that extend through the mounting bores 148 (best seen in FIG. 4A) of the base 130 and into the second frame 202 (FIG. 8). FIG. 9 illustrates an alternative mounting where the second member 104 may be mounted to a plate 212, disk, or the like disposed on the second frame 202.

Block 730 includes aligning the non-contact sensor 110 over the magnet 136 and providing a generally uniform gap 166 between the non-contact sensor 110 and the magnet 136 by disposing an alignment tool 106 around the first member 102 and the second member 104. In an embodiment, the non-contact sensor 110 is aligned over the magnet 136 is a first axial direction Y (side to side) and in a second axial direction X (front to back). The first axial direction Y and the second axial direction X are contained in the same plane. The first axial direction Y is perpendicular to the second axial direction X and to a third axial direction P that extends in the direction of the pivot axis P. Similarly, the second axial direction X is perpendicular to the first axial direction Y and to the third axial direction P. As the gap 166 extends along the third axial direction P, the gap 166 between the non-contact sensor 110 and the magnet 136 is perpendicular to the first and second axial directions Y, X.

In one embodiment, disposing an alignment tool 106 around the first member 102 and the second member 104 (that occurs in block 730) may include disposing the channel 160 around the first member 102 so that the inner surface 170 of the outer wall 164 of the channel 160 is in contact with the sidewall 118 of the housing 108 of the first member 102. The disposing may further include positioning the channel 160 (and first member 102) on top of the second member 104 so that the floor 150 is disposed on the platform surface 140 and the interfaces 156, and the stem 132 is received within the recess 168 of the inner wall 128. In another embodiment, disposing the alignment tool 106 around the first member 102 and the second member 104 may include positioning the first member 102 over the second member 104 and sliding the alignment tool 106 around both of the first and second members 102, 104. More specifically, sliding the alignment tool 106 so that the floor 150 slides over the platform surface 140 and the interfaces 156 of the first and second supports 134a, 134b until the outer wall 164 of the channel 160 rests against the sidewall 118 of the housing 108 of the first member 102 and the stem 132 is received in the recess 168 of the inner wall 128.

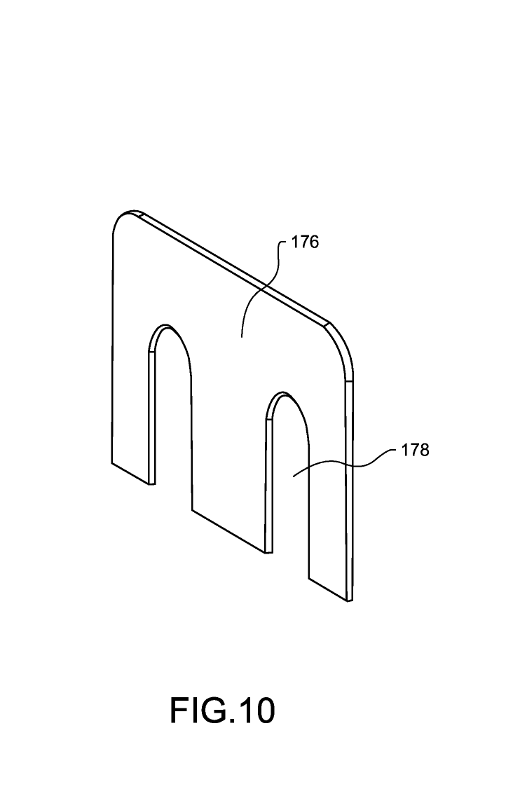

Block 740 includes mounting the first member 102 to the first frame 201. As shown in FIG. 8, in some embodiments, the first member 102 may be mounted on an extension member 174 by bolts or the like that extend through the bores 120 (FIG. 1) and into the extension member 174 (FIG. 8). In one embodiment, the extension member 174 may be a bracket, or the like. The extension member 174 may be mounted to the first frame 201 by bolts, or the like, that extend through the extension member 174 and into the first frame 201. In some embodiments, one or more shims 176 may be disposed between the extension member 174 and the first frame 201 in order to improve the alignment in the second axial direction X of the non-contact sensor 110 (of the first member 102) over the magnet 136 (of the second member 104) by increasing the distance between the first member 102 and the first frame 201. FIG. 10 illustrates one example of such a shim 176. In the exemplary embodiment of FIG. 10, the shim 176 is substantially flat with a generally uniform thickness. The shim 176 may have cut-outs 178 configured to allow the shim 176 to slide between the extension member 174 and the first frame 201 and around bolts, or the like, used to hold or mount the extension member 174 onto the first frame 201.

Block 750 includes removing the channel 160 of the alignment tool 106 from contact with the first and second members 102, 104. In one embodiment, the removing includes sliding the floor 150 of the channel 160 over the platform surface 140 and the interfaces 156 of the first and second supports 134a, 134b (in a direction away from the stem 132 and along the first axial direction Y) until the outer wall 164 of the channel 160 is free of the first member 102, the stem 132 is no longer received in the recess 168 of the inner wall 128, and the floor 150 is free of the platform surface 140 and each interface 156 of the first and second supports 134a, 134b.

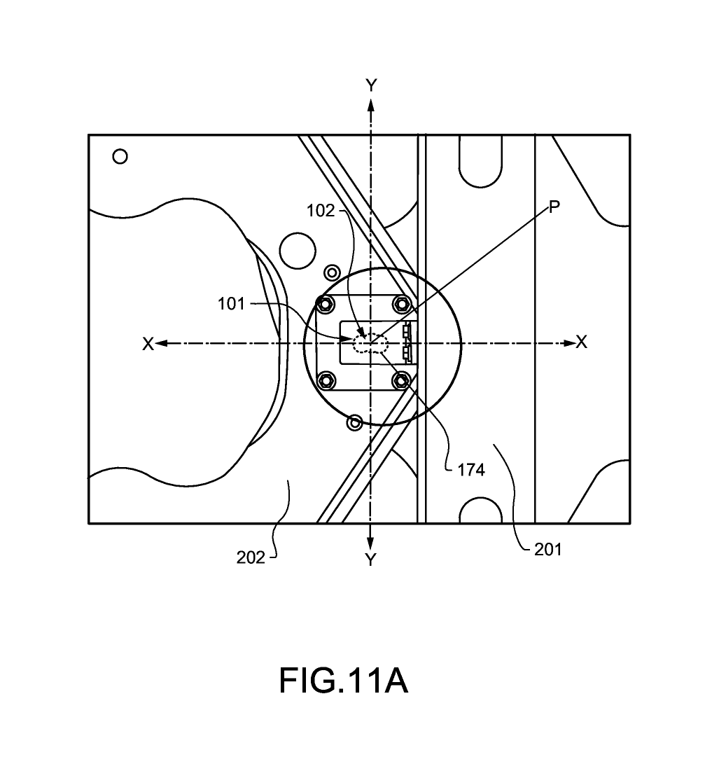

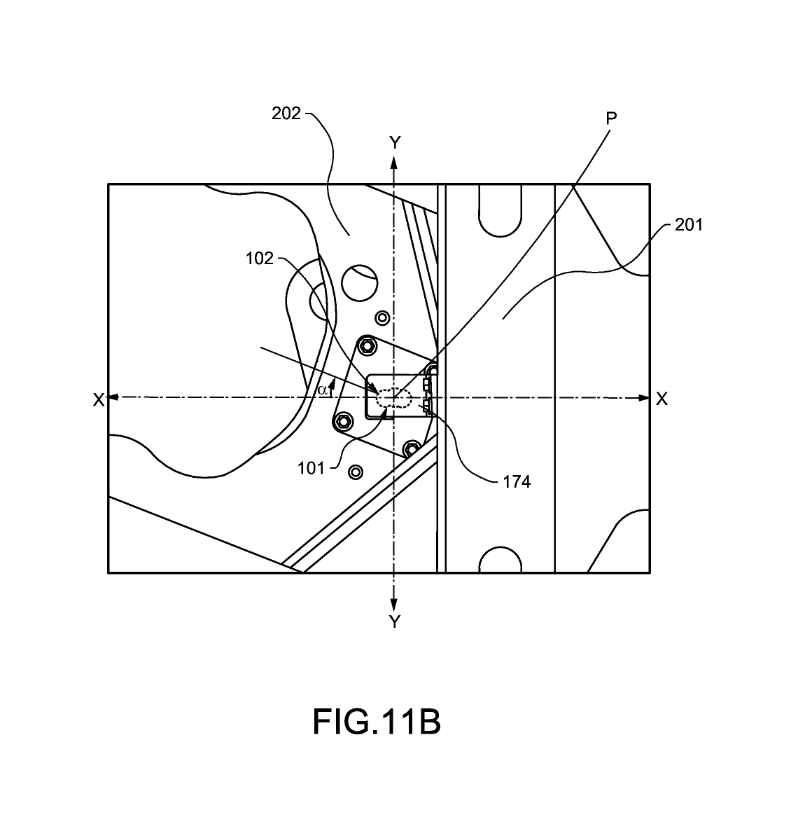

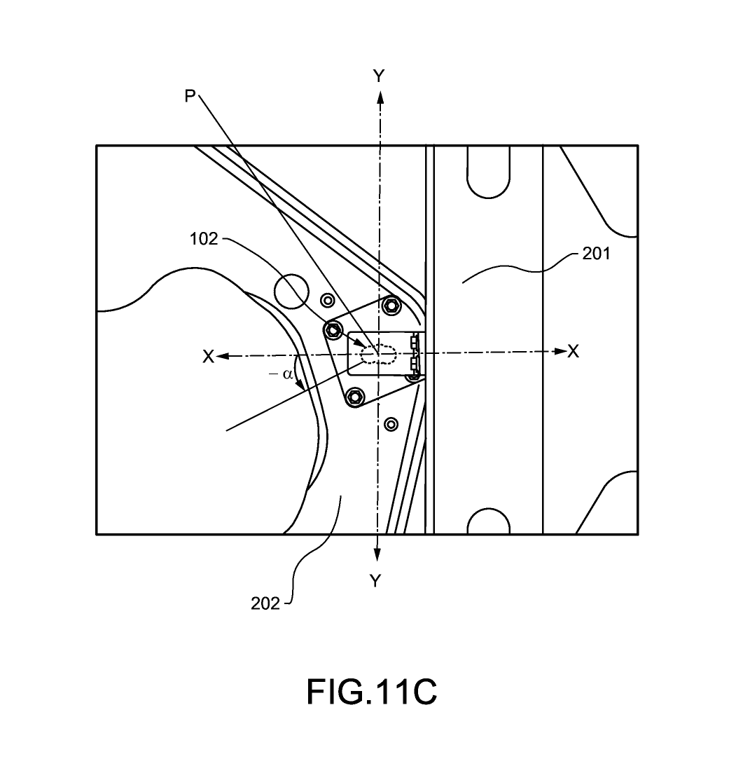

FIG. 11A illustrates an enlarged top view of an embodiment in which the first and second members 102, 104 have been mounted to the machine 200 of FIG. 6 using the method of FIG. 7. The first member 102 is mounted to the first frame 201 of the machine 200 by extension member 174, and the second member 104 (FIG. 8) is mounted to the second frame 202 of the machine 200. The non-contact sensor 110 of the first member 102 is aligned over the magnet 136 of the second member 104. Both the magnet 136 and the non-contact sensor 110 are centered substantially on the pivot axis P. In FIG. 11A, the first and second members 102, 104 are in the baseline position of about 0° displacement from the X-axis.

During operation the second frame 202 may axially articulate or pivot about the pivot axis P. When the second frame 202 pivots about the pivot axis P, the second member 104 pivots about the pivot axis P as well. As such, the magnet 136 disposed in the second member 104 rotates either clockwise or counterclockwise depending on whether the second frame 202 pivots to the left or pivots to the right. Because the intensity of the magnetic flux density of the magnet 136 varies with changes in the angular position/rotation of the magnet 136 with respect to the non-contact sensor 110, the non-contact sensor 110 can detect and measure the angular rotational displacement of the magnet 136 in relation to the baseline position (and by extension, the second frame 202) by sensing the intensity of the magnetic flux density of the magnet 136. The non-contact sensor 110 is configured to transmit a signal indicative of such displacement to a controller (not shown) either on the machine 200 or remote from the machine 200. In one embodiment, the signal may be a pulse width modulated (PWM) signal, in which the duty cycle of the PWM signal is indicative of the sensed intensity of the magnetic flux density and the angular displacement of the magnet 136 and the second frame 202.

When the second member 104 and its magnet 136 rotate on the pivot axis P clockwise as shown in FIG. 11B, the non-contact sensor 110 is configured to detect and measure the angular displacement α from the baseline position (about 0° displacement from the X-axis) and to generate and transmit a signal indicative of such measured displacement to a controller (not shown) either on the machine 200 or remote from the machine 200. For example, when there is about a 20° clockwise rotation, the non-contact sensor 110 may generate a signal with about a 70% duty cycle, whereas when there is approximately 0° rotation (FIG. 11A) the duty cycle may be about 50% and when there is about 20° counterclockwise rotation (FIG. 11C) the duty cycle may be about 20%. In one embodiment, the range of angular displacement may be plus or minus an angle α from the X-axis (baseline position). For example, the range of rotation and angular displacement may be from about −20° to about 20°. In other embodiments, a may be different value.

The features disclosed herein may be particularly beneficial to motor graders and other earth moving, construction, mining or material handling machines that utilize frames in which a second frame pivotally connected to a first frame.

What is claimed is:

1. An assembly of an alignment tool and a sensing apparatus, the assembly comprising:
a sensing apparatus including
a first member including a housing defining a chamber, and a non-contact sensor disposed in the chamber; and
a second member including:
a base including a side surface;
a stem disposed on the base, the stem defining a cavity;
first and second supports disposed on the side surface; and
a magnet disposed in the cavity; and
an alignment tool including:
a floor;
an inner wall disposed on the floor and defining a recess configured to receive the stem when the floor is disposed on the first and second supports; and
an outer wall spaced apart from the inner wall and disposed on the floor,
wherein the floor, inner wall and outer wall define a channel, the alignment tool configured to align the non-contact sensor over the magnet and to provide a gap between the non-contact sensor and the magnet when the channel is disposed between the first and second members.

2. The assembly of claim 1, in which the base further includes a platform surface, wherein the stem is disposed at least partially above the platform surface and the platform surface is configured to receive and slidingly release the floor of the alignment tool.

3. The assembly of claim 2, wherein the first and second supports are substantially disposed below the platform surface.

4. The assembly of claim 2, in which each of the first and second supports include an interface configured to receive the floor, each interface substantially in a plane of the platform surface.

5. The assembly of claim 1, wherein the channel is configured to align the non-contact sensor over the magnet in a first axial direction and in a second axial direction, the first and second axial directions contained in a first plane, the second axial direction perpendicular to the first axial direction, the gap extending from the second member to the first member in a third axial direction, the third axial direction perpendicular to the first and second axial directions.

6. The assembly of claim 1, wherein the channel is configured to provide the gap between the non-contact sensor and the magnet when the inner wall is disposed between the first member and the first and second supports.

7. The assembly of claim 1, in which the housing includes a sidewall, and in which the outer wall of the alignment tool has a reciprocal contour relative to a portion of the sidewall of the housing.

8. The assembly of claim 1, wherein the outer wall of the alignment tool is longer than the inner wall, and the non-contact sensor is a Hall effect sensor.

9. A method of assembling a sensing apparatus on a machine having a first frame and a second frame, the second frame pivotally connected to the first frame about a pivot axis, the sensing apparatus including a first member and a second member, the first member including a non-contact sensor, the second member including a magnet, the method comprising:
disposing a channel around the first member;
aligning the non-contact sensor over the magnet and providing a generally uniform gap between the non-contact sensor and the magnet by positioning the channel on the second member; and
removing the channel from contact with the first and second members.

10. The method of claim 9, in which the first member includes a housing having a sidewall, and the channel includes an outer wall, wherein the outer wall is in reciprocal contact with a portion of the sidewall of the housing after the disposing and before the removing.

11. The method of claim 9, in which the second member further includes a base having a side surface and first and second supports disposed on the base, and in which the aligning further includes positioning the channel on the first and second supports.

12. The method of claim 11, wherein the base has a stepped profile and includes a platform surface, and in which the aligning further includes positioning the channel on the platform surface.

13. The method of claim 12 further including, when the channel is positioned on the platform surface, receiving a stem of the second member in a recess defined by an inner wall of the channel, the recess external to the channel, the stem disposed above the platform surface.

14. The method of claim 9, wherein the non-contact sensor is aligned over the magnet in a first axial direction and in a second axial direction, the first and second axial directions contained in a plane, the first axial direction perpendicular to the second axial direction.

15. The method of claim 14, wherein the gap between the non-contact sensor and the magnet extends along the pivot axis, the pivot axis perpendicular to the first and second axial directions.

16. The method of claim 9, further including mounting the second member to the second frame.

17. The method of claim 9, further including mounting the first member to the first frame.

18. The method of claim 9, further including mounting the first member to the first frame with an extension member.

19. The method of claim 9, further including mounting the first member to the first frame with a bracket and at least one shim positioned between the bracket and the first frame.

20. A machine including:
a first frame;
a second frame pivotally connected to the first frame about a pivot axis;
a first member mounted on the first frame, the first member including a housing defining a chamber, and a Hall effect sensor disposed in the chamber, the Hall effect sensor configured to measure a pivotable displacement of the second frame with respect to the first frame based on rotational movement of a magnet aligned with the Hall effect sensor and further configured to generate a signal indicative of the pivotable displacement; and
a second member mounted on the second frame, the second member including
a base including a side surface;
a stem disposed on the base, the stem defining a cavity;
first and second supports disposed on the side surface; and
the magnet disposed in the cavity, wherein a gap is disposed between the first member and the second member.
